(19) United States
(12) Patent Application Publication
(10) Pub. No.: US 2021/0001342 A1
(43) Pub. Date: Jan. 7, 2021

(54) Microscope Slide File Position Flag and Method Related Thereto

(71) Applicant: Brian Lee Branton, Palmetto, FL (US)

(72) Inventor: Brian Lee Branton, Palmetto, FL (US)

(21) Appl. No.: 16/504,319

(22) Filed: Jul. 7, 2019

(51) Int. Cl. B01L 9/00

(52) U.S. Cl. CPC B01L 9/52; B01L 2300/12; B01L 2300/02; B01L 2300/0809

(57) ABSTRACT

The present invention describes a flag, or marker for identifying the locations of a plurality of microscope slides once removed from their storage locations within a microscope slide storage system. The invention comprises a molded polymer rectangular cuboid body member with rectangular front, rear, top, left, right, and bottom surfaces which follows the shape of a glass microscope slides, and the locations contained within a microscope slide storage system, with a recessed groove to accept one slide index marker card for recording the patient's case information, or other relevant information, and offers hard surfaces for recording additional identification modalities, which additionally provides a support structure for the neighboring microscope glass slides contained within said storage location.

Within prior art there are three means of storing specimen microscope slides dependent upon the orientation of the slide held within. 1. Vertical orientation: Microscope slides are stored in longitudinal drawer or box type configuration providing vertical orientations, whereby the slides are inserted standing on end within the drawer or box. The vertical orientation provides quick viewing of specimen labels and easy access to slides. The specimen microscope slides are positioned front to back within rows, within each drawer or container. 2. Horizontal orientation: Containers having defined compartments where pairs of laterally spaced sidewalls for receiving slides with a removable cover which forms a box. The sides of these storage boxes contain integrated ribbing which separates the slides from one another. Specimen microscope slides are inserted horizontally into these receptacle boxes, which offers limited viewing of slide's identification labels. 3. Horizontal Flat: Where the specimen microscope slides lay flat within the slide storage devices. Many slide mailing apparatuses provide a tray device with stops to prevent slides from touching during transport. The present invention is not applicable to Horizontal Flat microscope slide storage.

Other slide filing storage systems previously disclosed include: Ehrlich/Ehrlich U.S. Pat. No. 2,202,047—Sep. 3, 1937 which disclosed a cabinet for filing microscopic slides; Weiskopf U.S. Pat. No. 2,559,203—Jul. 3, 1951 which discloses a filing cabinet; Weiskopf U.S. Pat. No. 2,619,233—Nov. 25, 1952 which disclosed a slide filing means; Weiskopf U.S. Pat. No. 2,668,746—Feb. 9, 1954 which disclosed a filing cabinet and drawer for microscope slides; Asnes U.S. Pat. No. 3,235,068—Feb. 15, 1966 which disclosed a combination container and filing means for glass slides; Speelman U.S. Pat. No. 3,463,301—Aug. 26, 1969 which discloses a slide shipping and storage container.

In 1937, Ehrlich and Ehrlich patented the first vertically orientated slide filing cabinet designed for microscope slides, which offered higher density than the horizontal flat trays employed at that time. This design has been refined and adopted by many manufacturers today, and is still in production with only slight variations. There are other variations of vertically orientated microscope slide storage that utilizes cardboard outer boxes and internal plastic trays. In all, the microscope slide is always inserted on end, and in rows inside the drawer/tray/box/container.

With vertically oriented microscope slide storage systems a multitude of medical microscope slides are required to fill an entire drawer row. When slides are removed, the physical inclination of unsupported slides is to fall forward or backwards depending upon gravity, and other forces. A standard practice is to insert pieces of closed cell foam between or behind the slides, to provide support, to prevent the slides from laying down flat, or being broken.

With horizontal orientated slide containers specimen microscope slides are held upright and spaced with the ribbing incorporated into the sides of the containers. The incorporated ribbing provides proper spacing between slides so that the microscope slides do not fall or lay down against the neighboring slides. The container's ribbing does offer the necessary spacing of the remaining slides once a plurality of specimen microscope slides have been removed. The present invention addresses special considerations of the horizontal orientated storage containers in the detailed description section of this application.

As with all storage configurations medical librarians continually withdraw pluralities of specimen microscope slides from their respective row/drawer/box/storage locations as part of continuing patient care. The length of time at which these slides remain withdrawn is dependent upon the course of actions taken. Traditionally, when slides are removed from its storage system the librarian transcribes the particular specimen information onto a paperboard slide index marker, and this card is inserted into the area from whence the microscope slides were removed. These slide index markers are made from card stock paper, or paper board, and may incorporate preprinted lines for recording the patient's case information or the destination of the slides removed. These slide index marker cards only identify the location of the withdrawn slides and offer no support for the remaining slides within the row.

Microscope glass slides are available in a myriad of sizes and thicknesses. The standard medical microscope slides used in medical sciences commonly measures 75 mm×25 mm×1 mm or 3″×1″×1 mm, with other thicknesses offered in 1.1 mm and 1.2 mm. Glass microscope slides are typically optically clear being made from “water-white” colorless borosilicate glass, with a multitude of corner details, including 90° ground clipped corners, 45° ground corners, and 90° cut edge corners. Glass slides are offered in a plurality of treatments and designs, including, frosted or unfrosted, charged or uncharged, plain slide or prepainted slide ends for writing upon or engraving into the glass itself. Other microscope glass slides are treated with painted areas or regions specific to the type of specimen being affixed to each slide, the most common of these being a control microscope slides whereby a control specimen and the patient's specimen is affixed to the same microscope slide and processed with the procedural staining protocols. If the resulting stain produces the same positive results on both specimens, the indication points to a particular disease and would define the course of care for the patient. A multitude of other sizes of glass microscope slides are available. Some of the other standard sizes measure 76 mm×51 mm, 75 mm×50 mm, 48 mm×28 mm, and 46 mm×27 mm, and are available in other thicknesses, and are used throughout the scientific world.

In addition to the variations of microscope glass slides, the accompanying cover glass (sometimes referred to as the cover slip), is also offered in a multitude of sizes, thicknesses, and shapes, which depends upon the type of specimen previously affixed to the microscope glass slide. These variations include round cover glass in various diameters and thicknesses, and rectangular cover glass, also produced in a myriad of sizes and thicknesses, where the width of the cover glass never exceeds the width of the intended microscope glass slide.

### SUMMARY OF THE INVENTION

For a further understanding of the nature, and objects of the present invention, reference should be made to the detailed description taken in conjunction with the accompanying drawings. This invention fulfills the following roles; when a multitude of specimen microscope slides are removed from microscope slide storage systems, as a void is created by the removal of the microscope slides, the remaining slides tend to lean against the neighboring slides held within the drawer. If a sufficient number of slides are removed, the remaining slides encumber further removal of additional slides. As stated previously, slide index markers, (card stock markers), are inserted into the void created by the removal of medical slides. These cards mark the location of the withdrawn slides, but provides no physical presence to fill the void and prevent the surrounding glass slides from falling into the void. By using the invention, the microscope slide file position flag, the body of the invention is inserted into the void created by the slides. This invention will be made in a plurality of depths, and depended upon the number of microscope slides withdrawn, the librarian would insert a corresponding sized microscope slide file position flag equal to the number of slides removed to fill the void. Multiple microscope slide file position flags can be utilized together to fill larger voids. Once the void is filled the remaining slides would safely recline against the body of the invention, thus preventing the remaining slides from falling flat or being broken. Made from brightly colored polymers, the microscope slide file position flag would be easily visible against the remaining slides. Once the librarian returned with the previously removed slides, the invention flagging the location, would prompt a quick return of the removed slides.

The invention, in its horizontal embodiment, would be used in the same manner within the box type storage devices, whereby the wings are inserted into the integrated ribbing against the walls of the slide storage box. The body member being sized of various depths would fill the void of multiple slides within the horizontal storage box. The invention has been sized to fit within the box type slide storage systems, whereby the lid of the box can be return to the correct location.

### BRIEF DESCRIPTION OF DRAWINGS

FIG. 1 is a perspective view of an exemplary embodiment of two microscope slide file position flag of the present invention in use with a representative vertical microscope slide storage cabinet and drawer.

FIG. 2 is a perspective view of two embodiments of the present invention, the left shown in its vertical embodiment, the right shown in its horizontal embodiment.

FIG. 3 is a vertical cross-sectional view of the drawer of FIG. 1 taken along line 6 which shows the remaining glass slides interaction with the present invention.

FIG. 4 is a perspective view of two vertical embodiments of the present invention, the microscope slide file position flag on the left has a wedged surface (22) incorporated into the rear surface (14), the microscope slide file position flag on the right has a wedged surface (22) incorporated into the front surface (13).

FIG. 5 is a perspective view illustrating three horizontal embodiments of the microscope slide file position flags inserted into a slide storage box with the remaining microscope slides pictured.

FIG. 6 is a vertical cross-sectional view of the slide storage box of FIG. 5 taken along line 7 which shows the remaining glass slides interaction with the present invention.

FIG. 7 is a perspective view of a vertical embodiment of the present invention, positioned upon its back surface, with a comparable stack of microscope slide and cover glass to show a comparison to the thickness of the present invention.

FIG. 8 is a perspective view illustrating five variations of the present invention that incorporates differences into the body member.

FIG. 9 is a perspective view illustrating variations of the handle element (19) for the present invention.

### DETAILED DESCRIPTION OF PREFERRED EMBODIMENTS

Referring to the drawings, numeral (10) designates a embodiment of one microscope slide file position flag of the present invention in multiple images. Microscope slide file position flag (10) comprise a unitary block of molded polymer rectangular cuboid block that measures longer in length than one microscope glass slide, narrower in width than one microscope glass slide, the depth measures equal to the thickness of a specified plurality of microscope glass slides and coverglass stacked upon one another, a integrated handle, and recessed slot or groove for one slide index marker card with the body member.

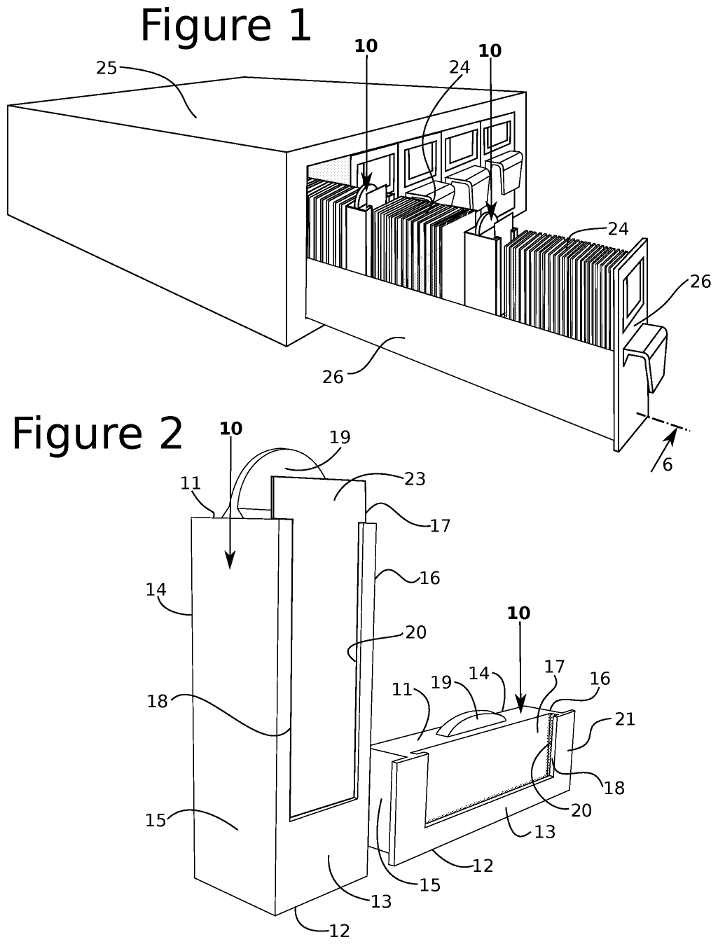

In FIG. 1 the microscope slide file position flag (10), is illustrated in combination with a microscope slide filing cabinet (25), positioned within a slide filing drawer (26), and the surrounding specimen microscope slides (24) contained therein. The body of the present invention (10) is inserted to fill the void created when a particular Patient's specimen microscope slides are removed from their storage location as part of the continuing patient care. Traditionally, the specimen microscope slides removed are to be reviewed by medical personnel via microscopy techniques.

Referring to FIG. 2, the microscope slide file position flags (10), hereto pictured as the two representations of the invention in their vertical and horizontal embodiments with preferably a rectangular top surface (11), a rectangular bottom surface (12), parallel and spaced apart from the top surface (11), a rectangular front surface (13), a rectangular rear surface (14), parallel to and spaced apart from the front surface (13), a rectangular left surface (15) a rectangular right surface (16), wherein the left surface (15) is parallel and spaced apart from the right surface (16), The front surface (13) has a rectangular area (17) displaced parallel to the front surface (13) forming the inner surface (17). Extending outwardly from the outer edges of the inner surface (17) are three substantially identical ends (18) forming channels with the front surface (13), whereby these channels (20) slidably receive a slide index marker card (23) within the slot or groove, where the top surface (11) incorporates a handle (19) extending above the flag body (10), and with the horizontal microscope slide position flag body (10) shown illustrated on the right, has the front surface (13) extending past the left (15) and right (16) surfaces to form wing surfaces (21) that together in combination with the front surface (13) equals the overall length of the specified microscope slide being replaced.

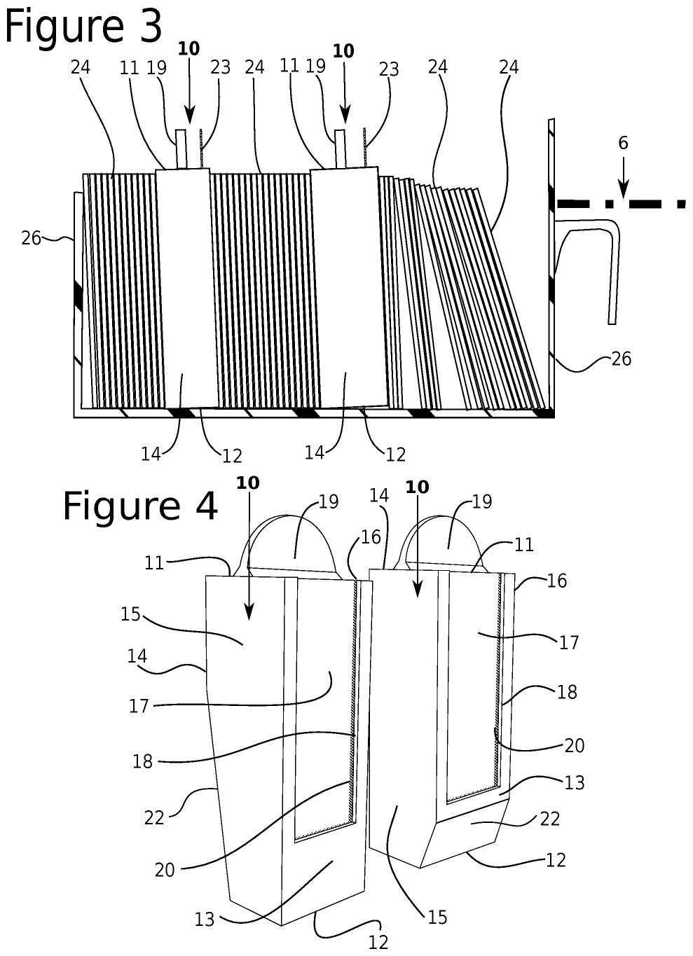

Referring to FIG. 3 illustrates a cross-sectional view of the slide drawer (26), from the slide filing cabinet (25) shown in FIG. 1, following along line (6), showing generally the contents of the file drawer, which denotes a plurality of vertically orientated specimen microscope slides (24) arranged in row in a “front to back” orientation, whereby the microscope slide file position flag (10) is engaged with and supporting the surrounding specimen microscope slides (24). The microscope slide file position flag (10) is capable of such positioning as it is not dependent upon the agreed classification systems utilized to file the specimen microscope slides within the storage system. The classification and patient's information is recorded upon the slide index marker (23), which is inserted into the groove (24) on the microscope slide file position flag body (10) for the represented “removed” specimen microscope slides.

Referring to FIG. 4 illustrates variations in the vertical oriented embodiment of the present invention (10), whereby the flag's body represented on the left has a wedged surface (22) shape incorporated into the rear surface (14), and the representation of the flag body (10) on the right, incorporates the wedged surface (22) shape into the front surface (13) below the recessed surface (17), and the ends (18) forming the groove (20). With the addition of the wedged surface (22) variation to the present invention, reduces the bottom surface (12) allowing the flag's body (10) to be inserted into voids where the surrounding specimen microscope slides have moved within the storage drawer/box reducing the overall space or gap. The wedged surface (22) shape allows the flag body (10) to push against the remaining microscope slides correcting the required spacing within the storage location.

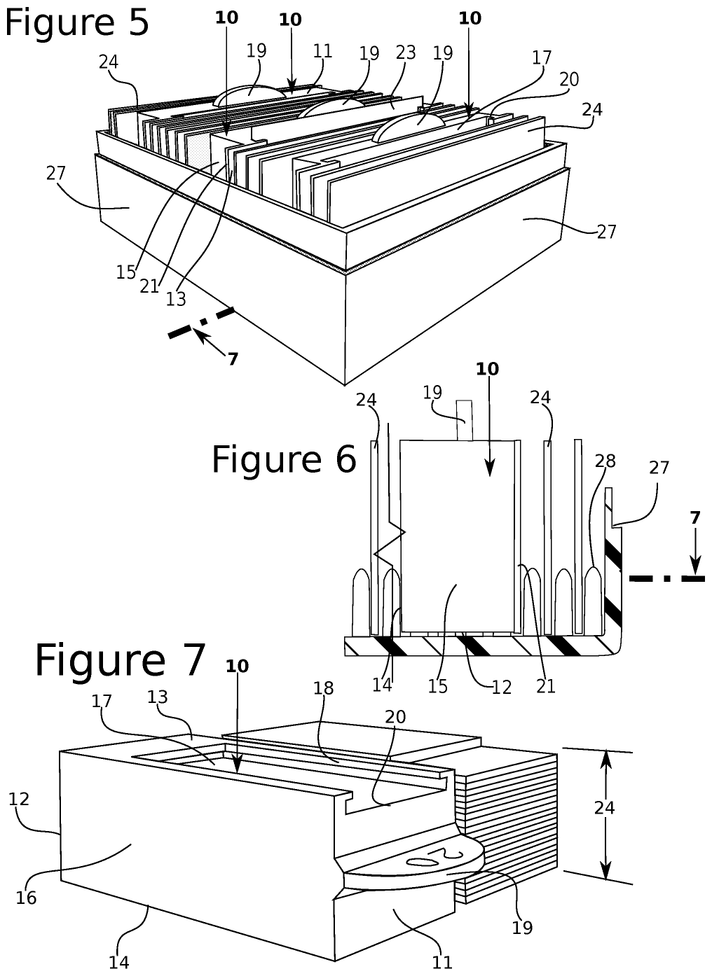

Referring to FIG. 5 illustrates a perspective view of one horizontally oriented microscope slide file storage box (27), with three microscope slide file position flags (10), or the present invention, of various sizes (thicknesses) in used in conjunction with other remaining specimen microscope slides. The center embodiment shown has the slide index card (23) inserted for a visual reference of the height compared to the surrounding microscope slides. Note how the front surface (13) and the wing surfaces (21) combined are of the same length as the specimen microscope slides pictured.

Referring to FIG. 6 shows a cross-sectional view of FIG. 5. taken alone line (7) illustrates the horizontal embodiment of the present invention inside the microscope slide storage box (27), which depicts the interaction of the microscope slide file position flags (10), and the container's integrated ribbing (28) of the slide storage box (27). Whereby the noted front surface (13) and the combined wing surfaces (21) utilize the integrated ribbing (28) of the slide storage box (27) to provide the correct spacing for the “removed” specimen microscope slides.

Referring to FIG. 7 illustrates one vertical embodiment of the present invention (10), positioned upon its back surface (12), adjacent to a representation of a corresponding stack of specimen microscope slides (24) with cover glass to provide a reference that the microscope slide file position flag (10) is equal to a set number of like specimen microscope slides (24). Each microscope slide file position flag (10) is embossed, engraved, or labeled with a number designating the thickness of slides represented by the body of the present invention.

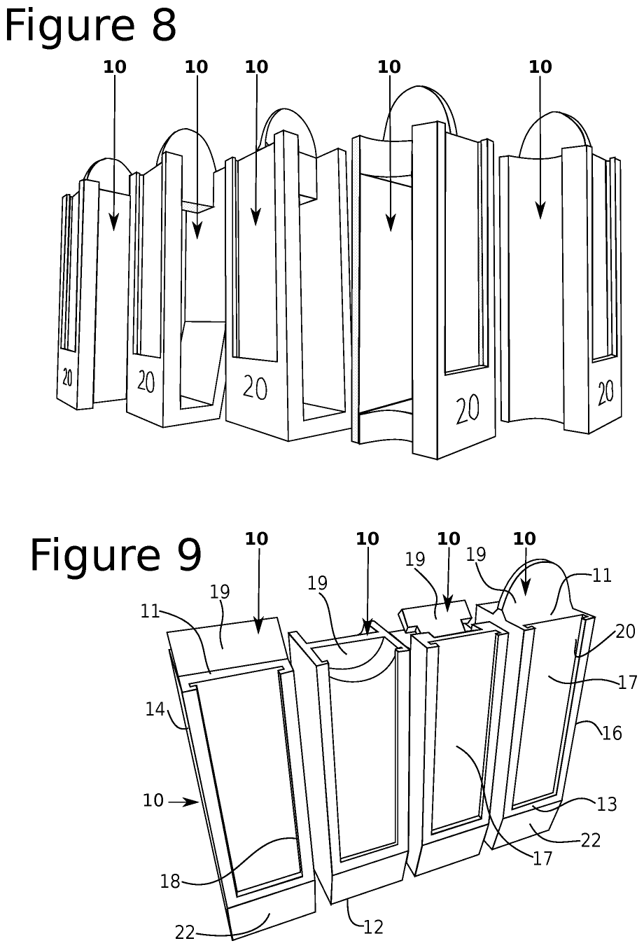

Referring to FIG. 8, the present invention (10) is shown in a plurality of forms where the entire body member (10) is reduced to the front surface (13), rear surface (14), bottom surface (12), recessed surface (17), groove (20) for the slide index card (23), and the handle (19). The remaining left surfaces (15), right surface (16), and top surface (11) have been reduced to minimal proportions, but remain to provide structural elements to the remaining surfaces. The five variations represented are example modifications and may not be reflected in the final embodiment.

FIG. 9 illustrates four variations of the present invention, or body members of the microscope slide file position flag (10), with modifications to the handle member (19) utilized when inserting and removing the body member from a specimen microscope slide file location. The four examples shown are only a few of the conceivable variations to the handle member (19) possible, and may not reflect upon the final embodiment.

Today the universal use of microscope glass slides and cover glass utilized in multitudes of uses, designs, and functions are well beyond the scope of the present invention. It is the intent for the microscope slide file position flag (10) to fulfill the role in which it it has been described and detailed herein. Although the aforementioned interpretation of the present invention will be offered with variations in its design and function, the final embodiment, without departing from the spirit and scope, will universally provide a means whereby persons utilizing this invention might ultimately ease their daily routines when interacting with microscope slide storage systems, with the use of the microscope slide file position flag (10), as hereinafter claimed.

What is claimed is:

1: A microscope slide file position flag comprise:

1.1: A body member having a front and opposing parallel rear surfaces spaced apart equal to a predetermined plurality thickness of stacked microscope slides with cover glass, whereby the front and rear surface maintain the correct spacing within the void created when a plurality of specimen microscope slides are removed from a vertically or horizontally orientated microscope slide filing storage system.

1.2: A body member here described is best defined as a rectangular cuboid block as it follows the inherent shape of tissue cassettes, with other geometric shapes providing the same opposing surfaces to fill voids created from withdrawn tissue blocks within a storage system, including cylinders, elongated spheres, rounded cubes, or any other physical form.

1.3: Within the body member provisions are incorporated into its surfaces to receive one slide index card, whereby the slide index card is visible on one of its front surfaces, or other provisions for writing or recording pertinent patent information onto any of the surfaces, can be incorporated into the final design.

1.4: Other identification mechanisms may be incorporated into or onto the physical surfaces of the body member, which includes integrated writing surfaces, all forms of permanent or removable labels, bar codes, RFID devices, memory chips, or other electronic identification apparatus as desired.

2. The microscope slide file position flag of claim 1, in which the body member's front and parallel rear surfaces are proportioned to equal the length and width of the corresponding microscope slides that the body member, would replace once removed from the microscope slide storage system. Each of the flag body members displays the corresponding number of slides that each body member's thickness represents, this number can be embossed, engraved, or surface labeled. An example: The number 25 would be engraved into all flag body members that measure the same thickness as 25 microscope glass slides with cover glass.

3. The microscope slide file position flag of claim 1 and claim 2, body member can be manufactured of multiple materials, including, but not limited too, 3D printed polymers, injection molded polymers, other plastics, paperboard, cardboard, wood, metal, glass, sand, plaster, cement, wax, rubber, and any other material that will hold the body member's form.

4. A method of use of the microscope slide file position flag comprise the steps of:

4.1: Providing a device to be utilized when interacting with a microscope slide filing storage systems with detailed, and accountable record management modalities, whereas when a plurality of microscope slides containing previously mounted specimens are removed from said storage systems, the void created within said storage is infilled with the body of the present invention.

4.2: Providing a means by where a representation, (the invention), of said “removed” slides will allow the librarians to differentiate the location of the withdrawn slides without having to re-index the entire storage location against the other or remaining slides contained therein, by providing a convenient and integrated location for devices such as a slide index card, or some other notation devices which is attached to or embedded within the present invention, to allow the librarian to record pertinent information pertaining to the slides removed which will remain with the invention held in the storage location.

4.3: The present invention will be offered in a multitude of colors, variations in sizes, and thicknesses, (equal to a predetermined number of microscope slides), to be useful in the daily management of microscope slides held with a complex microscope slide storage facility.
